(19) United States
(12) Patent Application Publication
(10) Pub. No.: US 2013/0128021 A1
(43) Pub. Date: May 23, 2013

(54) ROTATABLE PRESENTATION BILLBOARD

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/484,292

(22) Filed: May 31, 2012

(30) Foreign Application Priority Data
Nov. 17, 2011 (TW) 100142021

(51) Int. Cl. H04N 7/18

(52) U.S. Cl. 348/77; 348/E07.085

(57) ABSTRACT

A billboard includes an image capturing device, a processor, and a driving unit. The image capturing device uses a camera to capture consecutive scene images of a scene area. The processor uses a geometric figure to mark a figure in each captured image. If the center of the geometric figure is not the center of the captured image, the processor generates a control signal to direct the driving unit to rotate the billboard until the center of the geometric figure is the center of the captured image.

### BACKGROUND

1. Technical Field

The disclosure relates to billboards, and particularly to a rotatable presentation billboard.

2. Description of Related Art

Rotatable billboards are rotated in a fixed direction periodically, for example, in a left-to-right direction. When a user looks at such a billboard, he or she has, sometimes, to move along the rotating direction following the billboard to order to get enough information from the billboard, which is inconvenient for the user.

Therefore, what is needed is a new rotatable presentation billboard to overcome the described shortcoming.

### BRIEF DESCRIPTION OF THE DRAWINGS

FIG. 1 is a block diagram of a rotatable presentation billboard in accordance with an exemplary embodiment.

FIGS. 2-5 are schematic diagrams showing continuous scene images captured by the rotatable presentation billboard of FIG. 1.

### DETAILED DESCRIPTION

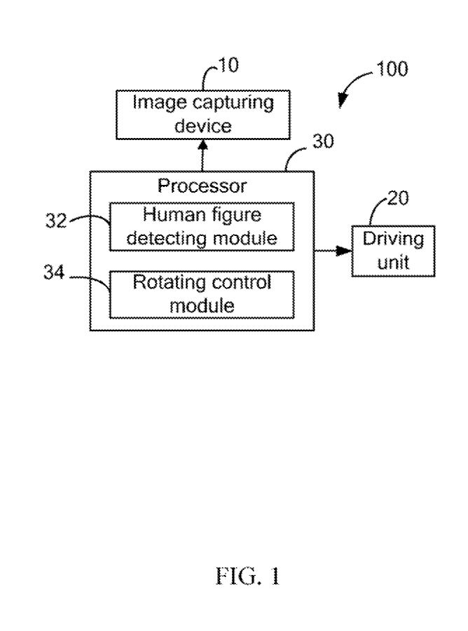

FIG. 1 is a block diagram of a rotatable presentation billboard in accordance with an exemplary embodiment. The rotatable presentation billboard (hereinafter “billboard”) 100 includes an image capturing device 10, a processor 20, and a driving unit 30. The image capturing device 10 is on the top of the billboard 100, optimally, the image capturing device 10 is in the middle of the top of the billboard 100.

The image capturing device 10 includes at least one camera to capture a number of consecutive scene images of a scene area. In the embodiment, the image capturing device 10 includes one camera. The driving unit 20 drives the billboard 100 to rotate under the control of the processor 30. In the embodiment, the driving unit 20 is a motor.

The processor 30 includes a human figure detecting module 32 and a rotating control module 34. The human figure detecting module 32 determines whether one scene image of the number of consecutive scene images captured by the image capturing device 10 includes a human figure based on a human figure detecting technology. The human figure detecting technology is well known and thus not described here.

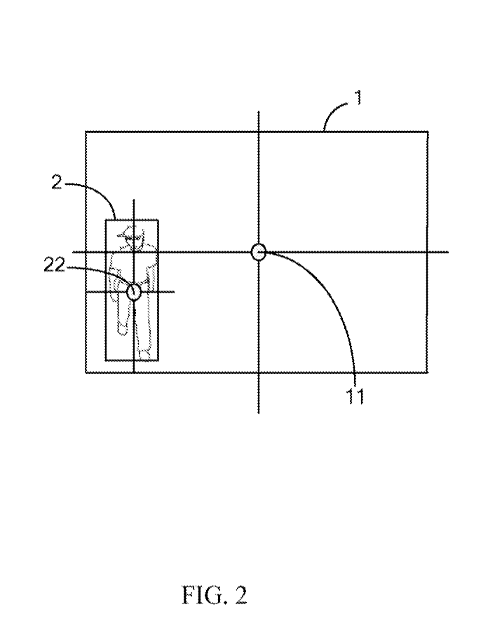

When the human figure detecting module 32 determines that one scene image of the number of consecutive scene images captured by the image capturing device 10 includes a human figure, the rotating control module 34 uses a geometric figure to mark the human figure in the detected scene image and determines whether the center of the geometric figure is the center of the detected scene image. In one embodiment, the geometric figure is a rectangle 2 as shown in FIG. 2-5 or a circle.

If the center 22 of the geometric FIG. 2 is not the center 11 of the detected scene image 1, that means that both the centers 22, 11 of the geometric FIG. 2 and the detected scene image 1 do not coincide, the rotating control module 34 further generates a first control signal to direct the driving unit 20 to rotate the billboard 100 until the center 22 of the geometric FIG. 2 is the center 11 of the detected scene image 1.

If the center 22 of the geometric FIG. 2 is the center 11 of the detected scene image 1, that means that both the centers 22, 11 of the geometric FIG. 2 and the detected scene image 1 coincide, the rotating control module 34 further generates a second control signal to direct the driving unit 20 to stop rotating the billboard 100.

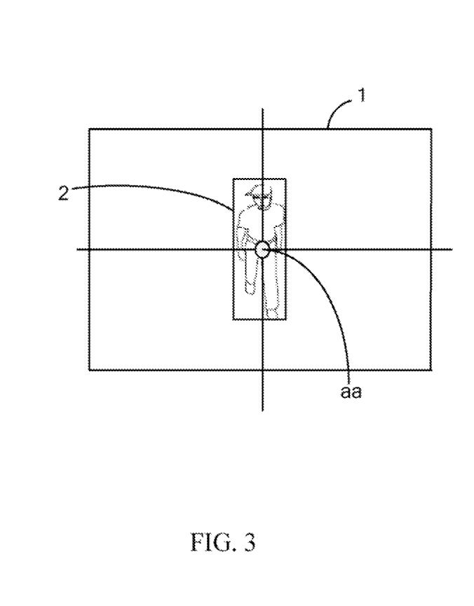

As shown in FIG. 2, the rotating control module 34 detects that the center 22 of the geometric FIG. 2 is not the center 11 of the detected scene image 1, and directs the driving unit 20 to rotate the billboard 100 to cause the center 22 of the geometric FIG. 2 to become gradually closer to the center 11 of the corresponding detected scene image 1. As shown in FIG. 3, if the center 22 of the geometric FIG. 2 is the center 11 of the detected scene image 1, that is, the centers 22, 11 coincide at the point aa, the rotating control module 34 further controls the driving unit 20 to stop rotating the billboard 100. Therefore, a user corresponding to the human figure can comfortably look at the information displayed on the billboard 100 without extra movement.

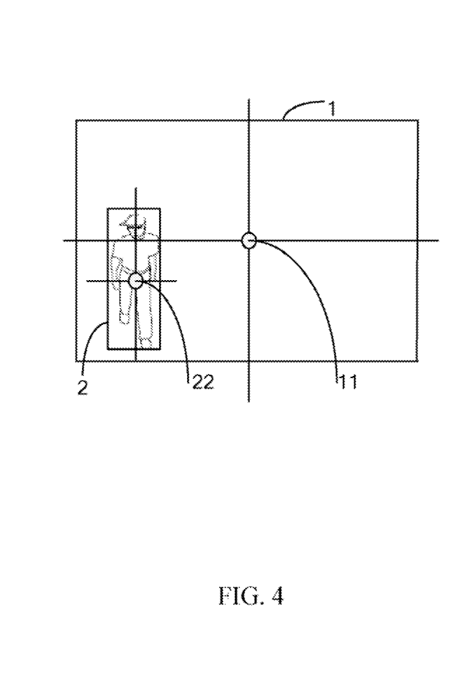

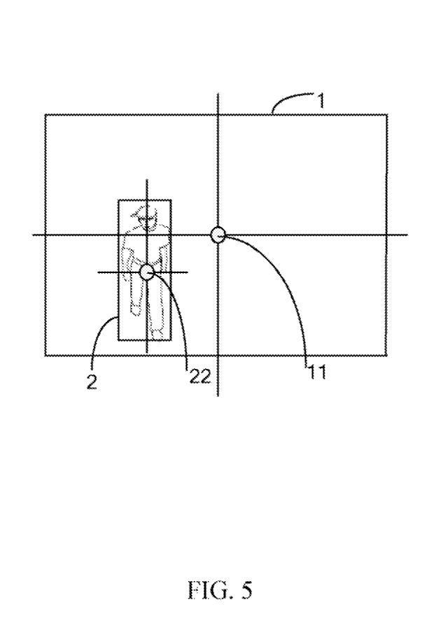

In another embodiment, for accurately rotating the billboard 100, the image capturing device 10 includes at least two cameras and uses each of the at least two cameras to capture a number of consecutive scene images of a scene area. When detecting a scene image including a human figure in the number of consecutive scene images of each scene area, for example, as shown in FIGS. 4 and 5, the rotating control module 34 uses the geometric FIG. 2 to mark the human figure in each detected scene image 1, then obtains a difference between the center 22 of the geometric FIG. 2 and the center 11 of each detected scene image 1 to determine a detected scene image whose center is the nearest to the center of the corresponding geometric figure.

The rotating control module 34 directs the driving unit 20 to rotate the billboard 100 based on the shortest difference between the center of the geometric figure and the center of the detected scene image to make sure that the center of the geometric figure is gradually closer to the center of the corresponding detected scene image until the center of the geometric figure is the center of the detected scene image. If the center of the geometric figure is the center of the detected scene image, the rotating control module 34 directs the driving unit 20 to stop rotating the billboard 100.

For example, as shown in FIGS. 4 and 5, the image capturing device 10 includes at least two cameras and uses each of the at least two cameras to capture a number of consecutive scene images of a scene area. The rotating control module 34 obtains a difference between the center 22 of the geometric FIG. 2 in FIG. 4 and the center 11 of each detected scene image 1 in FIG. 5, compared FIG. 4 to FIG. 5, the difference between the centers 22, 11 in FIG. 4 is larger than the difference between the centers 22, 11 in FIG. 5. Therefore, the rotating control module 34 directs the driving unit 20 to rotate the billboard 100 based on the difference of FIG. 5.

Furthermore, each of the at least two cameras includes a priority level. If the difference between the center of the geometric figure and the center of each detected scene image is equal, the rotating control module 34 directs the driving unit 20 to rotate the billboard 100 based on the difference between the center of the geometric figure and the center of one detected scene image captured by the highest priority camera.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A rotatable presentation billboard comprising:
an image capturing device which comprises at least one camera to capture a plurality of consecutive scene images of a scene area;
a driving unit to drive the billboard to rotate; and
a processor to detect a scene image comprising a human figure in the plurality of consecutive scene images, use a geometric figure to mark the human figure in the detected scene image, determine whether the center of the geometric figure is the center of the detected scene image, if the center of the geometric figure is not the center of the detected scene image, generate a first control signal to direct the driving unit to rotate the billboard until the center of the geometric figure is the center of the detected scene image, and if the center of the geometric figure is the center of the detected scene image, generate a second control signal to direct the driving unit to stop rotating the billboard.

2. The rotatable presentation billboard as recited in claim 1, wherein the driving unit is a motor.

3. The rotatable presentation billboard as recited in claim 1, wherein the image capturing device comprises a camera.

4. The rotatable presentation billboard as recited in claim 1, wherein the image capturing device comprises at least two cameras and uses each of the at least two cameras to capture a plurality of consecutive scene images of a scene area, when detecting a scene image comprising a human figure in the plurality of consecutive scene images of each scene area, the processor is configured to use the geometric figure to mark the human figure in each detected scene image, obtain a difference between the center of the geometric figure and the center of each detected scene image to determine a detected scene image whose center is the nearest to the center of the corresponding geometric figure, direct the driving unit to rotate the billboard based on the shortest difference between the center of the geometric figure and the center of the detected scene image to make sure that the center of the geometric figure is gradually closer to the center of the corresponding detected scene image until the center of the geometric figure is the center of the detected scene image, and if the center of the geometric figure is the center of the detected scene image, direct the driving unit to stop rotating the billboard.

5. The rotatable presentation billboard as recited in claim 4, wherein each of the at least two cameras comprises a priority level, if the difference between the center of the geometric figure and the center of each detected scene image is equal, the processor directs the driving unit to rotate the billboard based on the difference between the center of the geometric figure and the center of one detected scene image captured by the highest priority camera.

6. The rotatable presentation billboard as recited in claim 1, wherein the geometric figure is a rectangle.

7. The rotatable presentation billboard as recited in claim 1, wherein the geometric figure is a circle.
